(19) United States
(12) Patent Application Publication
(10) Pub. No.: US 2006/0283787 A1
(43) Pub. Date: Dec. 21, 2006

(54) Integrated Advanced Simultaneous Oxidation Process (ASOP) to Defeat Chemical, Biological, and Radiological Agents in Aqueous and/or other Fluid Solutions

(76) Inventors: Vincent J. Ciccone Pedee, Woodbridge, VA (US); William E. Kirksey Pe, Woodbridge, VA (US)

Correspondence Address: DR. VINCENT J. CICCONE, PE, 1635-2 WOODSIDE DRIVE, WOODBRIDGE, VA, 22191, US

(21) Appl. No.: 11/276,879

(22) Filed: Mar. 17, 2006

Related U.S. Application Data
(60) Provisional application No. 60/595,270, filed on Jun. 20, 2005.
(60) Provisional application No. 60/595,272, filed on Jun. 20, 2005.

(51) Int. Cl. B01D 35/00

(52) U.S. Cl. 210/85; 210/96.1; 210/259; 210/202; 210/241

(57) ABSTRACT

The Hyd-RO-Secure™ System combines individual elements of aqueous and other fluid treatment technology into a treatment train including various devices for pre-treatment tailored to the source solution, a conventional reverse osmosis membrane treatment process, a RASco-designed Advanced Simultaneous Oxidation Process (ASOP™), and various devices for post-treatment tailored to the characteristics of the end-user needs and demand patterns; wherein the combination of technologies create a unique system for safely and cost-effectively removing chemical, biological, or radiological contamination from aqueous solutions.

### CROSS-REFERENCE TO RELATED APPLICATIONS

This Application references and claims priority through Provisional Application No. 60/595,270, filed Jun. 27, 2005 and is related to the Provisional Application No. 60/595,272 “A Simplified Device for Converting UV Chambers to an O₃/UV Advanced Simultaneous Oxidation Process Reactor for the Treatment of Fluids”

### FEDERALLY SPONSORED R&D

This invention was made with Government support under CONTRACT DAAD05-03-C-0042 DI-ADMN-81373Task #1403 awarded by the Technical Support Working Group, Combating Terrorism Technology Support Office, Department of Defense. The development of the invention described in this Provisional Patent Application was conducted by the inventors as part of the project “Water Treatment System for Critical Facilities”. The work has been designated as FOUO restricted information by TSWG. The Government has certain rights in the invention.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO INFORMATION ON A CD

Not Applicable. There is no CD included with additional information.

### BACKGROUND OF THE INVENTION

Contamination in aqueous or other fluid solutions (either intentional, accidental, or naturally occurring) is a problem that occurs in many forms, including drinking water, industrial and agricultural waste, and municipal wastewater. A wide variety of pollution control and treatment devices have been developed and employed across the spectrum of uses.

In addition, serious chemical, biological, and radiological threats from terrorists exist to water supplies, particularly at the “point of entry” (POE) for government, corporate, and other “icon” facilities. These threats are well documented by terrorism and water supply experts. Strategies to address threats to water supplies have focused primarily on increased vigilance and access control at central treatment facilities; however, these strategies require significant resources and are likely to be ineffective due to the dispersed nature of the water distribution system and the risk of contamination after the water has left the treatment facility.

The RASco, Inc. Hyd-RO-Secure™ system is a flexible treatment process that can deal with a wide variety of contamination in aqueous and other fluid solutions. The system consists of a specialized, inline water purification technology that defends against chemical, biological, and radiological (CBR) contamination whether caused by accident, intention, or natural processes. The Hyd-RO-Secure™ system can address the wide variety of pollution control and clean-up tasks that are issues in industrial and agricultural discharges, groundwater, and surface waters.

As a priority use, Hyd-RO-Secure™ offers protection against attacks to a facility, while providing pure, palatable drinking water that meets or betters safe water standards. The system is designed to reduce the risks to operations and staff at a variety of critical facilities including government buildings and installations, embassies, military bases, command and control facilities, corporate headquarters, health care institutions, and other secure or public venues. The Hyd-RO-Secure™ system is composed primarily of commercial off-the-shelf (COTS) technology configured in an integrated, proprietary unit, including one module covered under a separate Patent Application (reference provisional Patent Application No. 60/595,272), and one component that was patented previously by RASco, Inc (The Reverse Osmosis Multi Element Module [ROMEM™], U.S. Pat. No. 4,476,015). The Hyd-RO-Secure™ system has been demonstrated in independent tests to defeat a wide variety of threat agents.

The technology offers a treatment system for aqueous and other fluid solutions that, cost-effectively produces large quantities of safe product to meet user needs, whether the need is for drinking water, surface discharge, industrial waste treatment, high-quality process water, or medical water. The system can operate to meet daily needs or to provide protection in the event of a CBR attack.

### BRIEF SUMMARY OF THE INVENTION

The Hyd-RO-Secure™ System combines individual elements of fluid treatment technology into a treatment train including various devices for pre-treatment tailored to the source solution, a conventional reverse osmosis membrane treatment process, a RASco-designed Advanced Simultaneous Oxidation Process (ASOP™—reference provisional Patent Application No. 60/595,272), and various devices for post-treatment tailored to the characteristics of the end-user needs and demand patterns; wherein the combination of technologies create a unique system for safely and cost-effectively removing chemical, biological, or radiological contamination from aqueous and other fluid solutions.

### BRIEF DESCRIPTION OF THE DRAWING

The Drawing illustrates the major modules of the Hyd-RO-Secure™ system, the specific technologies included in each module, and the direction of flow through the system.

### DETAILED DESCRIPTION OF THE INVENTION

a) Process Description

This application describes an integrated treatment system for aqueous solutions designed to treat contamination from Chemical, Biological, or Radiological (CBR) Agents. The system is flexible and can be tailored to serve a wide variety of treatment needs. For example, a major application of the system is expected to be for anti-terrorism and force protection (AT/FP). The system can operate inline in an “always on” condition to perform effective treatment of water (to USEPA Safe Drinking Water Standards) and other fluids without the need for sensing or identifying incoming threat agents; however, the system can also operate in a batch processing mode to process wastes (e.g. agricultural runoff) that do not arrive in a continuous stream. A programmable logic controller (PLC) system is an option in the system, and can provide automated threat sensing, control of system modules, remote monitoring and control, and data logging and analysis. In addition, the PLC can be combined with a device to shunt to drain incoming water under appropriate conditions (e.g., high levels of radioactivity).

The process may combine Commercial-Off-The-Shelf (COTS) technology with an existing patent held by RASco, Inc. (the ROMEM™, U.S. Pat. No. 4,476,015) and a new device, an Advanced Simultaneous Oxidation Process (ASOP™), covered under Provisional Application No. 60/595,272 filed by RASco. The integrated system is known as the Hyd-RO-Secure™ AT/FP Water Treatment System.

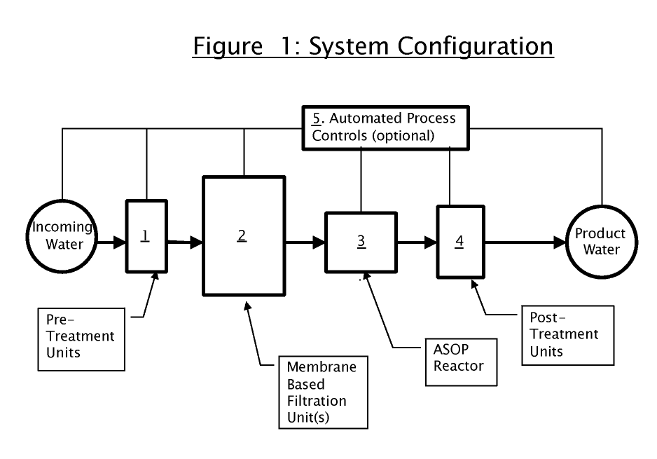

The Integrated Process is composed of the following components (shown in FIG. 1) in the sequence specified:
(1) A gateway module, containing a sensor for incoming contamination or threat agents that might be introduced into the water or fluid and a high-speed, motor controlled valve to close the system and divert the water or fluid to a drain or exhaust if appropriate (for example in the case of highly radioactive agents). This automated shut-off capability is an optional feature and is not necessary for the treatment processing function of the Hyd-RO-Secure™ AT/FP Water Treatment System.
(2) One or more pre-treatment units tailored to the characteristics of the incoming solution to be treated. These units could include screens, particulate filters, activated carbon tanks, or other devices to physically and chemically prepare the incoming stream for the treatment process.
(3) One or more membrane filter units as the primary treatment for CBR contamination. These filter units may be configured with RASco's Reverse Osmosis Multi Element Module (ROMEM™, U.S. Pat. No. 4,476,015) device to improve efficiency, service life, and ease of maintenance; however, depending on physical space characteristics in certain fixed installations, the RO units may be installed without the ROMEM™.
(4) An Advanced Simultaneous Oxidation Process (ASOP™) reactor to destroy any chemical or biological contamination remaining after the reverse osmosis. The ASOP™ reactor is described in Provisional Patent Application 60/575,272, and includes an oxidation source, an ultraviolet radiation source, a mixing device, and a reactor vessel.
(5) One or more post-treatment units, which could include: activated carbon tanks to adsorb any remaining organic and volatile organic chemicals and any remaining oxidant; an ion exchange tank (either inline or on standby) to help treat extremely high levels of contaminant; a calcite tank to add minerals to improve taste and adjust pH of the product; a chemical injector to add residual disinfectant for a drinking water distribution system; or other post-treatment as required by the specific installation.
(6) A programmable logic controller (PLC) to integrate system function and sequencing links, and monitor, and manage all other components. Such a controller also provides system monitoring, both onsite and remotely, and allows data logging to store and compile reports of operation for later operator/management analysis. In addition to this fully automated operational mode, the system is designed so that it may be configured to operate in a manual mode with varying degrees of monitoring information and alarm indications provided by the individual unit components depending on operating needs.

b. Uses of the System

The process described above can be used in a variety of configurations; such varied uses are included in this application. In particular, likely applications of this process include:
(1) Drinking water for permanent, fixed installations designed to serve and protect existing or new facilities such as government buildings, institutional buildings or campuses, commercial buildings (e.g. hotels, shopping malls, amusement parks, etc.), sports arenas or concert facilities, or other public/private icon facilities.
(2) Mobile, skid-mounted systems that can be mass-produced and transported as a self contained unit to be installed on short notice for protection at specific sites (e.g., military bases, overseas government facilities, overseas civilian facilities, major sporting or cultural events, etc.).
(3) Mobile systems mounted on a truck or trailer (including systems configured with a self contained power generator) for deployment in emergency conditions to provide disaster relief, rapid clean up after events that result in contaminated water, and supplemental water treatment during temporary water shortages due to municipal equipment malfunction or damage.
(4) Tailored systems developed for specific treatment purposes, for example hospital or industrial usage or treatment of air in HVAC systems in which post-treatment equipment may be added to the system to provide for facility specific usage.

c). Construction of the System

The COTS components of the system are assembled using the conventional practices of mechanical, electrical, and plumbing construction. The ROMEM™ device is added to the RO membrane housings according to instructions provided by RASco. And the design of the ASOP™ Reactor is covered in Provisional Patent Application (No. 60/595,272).

The process described can vary widely in size and resulting product volume, cost-effectively ranging on the low end from 1 to 5 gallons per minute to several 100 gallons per minute on the high end. Depending on the physical space available for the system and logistic considerations, multiple modules can be more appropriate than one large one.

What is claimed is:

1. The ability to defeat Chemical, Biological, and Radiological (CBR) agents in aqueous and other fluid solutions and produce pure drinking water (meeting USEPA Safe Drinking Water Act standards) through the use of a uniquely configured, integrated treatment system. The integrated system functions as follows:
a. Provides pre-treatment to prepare the aqueous or fluid solution physically and chemically using one or more carbon tanks, sized appropriately for the installation, and other pre-treatment devices as may be required for specific characteristics of the incoming water. The other devices could include, but are not limited to screens, particulate filters, activated carbon tanks, etc
b. Provides primary treatment through one or more reverse osmosis (RO) filter units, which may be configured with RASco's Reverse Osmosis Multi Element Module (ROMEM, U.S. Pat. No. 4,476,015)
c. Provides enhanced primary treatment through an Advanced Simultaneous Oxidation Process (ASOP) reactor as described in Provisional Patent Application No. 60/595,272, which includes an oxidation source, an ultraviolet radiation source, an oxidant diffusion device, and a reactor vessel to destroy contaminants remaining after the RO treatment
d. Provides post-treatment through the use of devices such as: activated carbon tanks to adsorb any remaining organic and volatile organic chemicals and any remaining oxidant; a calcite tank to add minerals, improve taste, and adjust pH of the product; a chlorine injector to add residual disinfectant for water distribution systems; or other post-treatment as required by the specific installation and fluid treated.
e. Provides enhanced post-treatment through an ion exchange tank (either inline or on standby) to help treat specific types of threat agent.

2. The capacity to identify incoming threat agents through sensors in the incoming aqueous stream and electronically signal a motor controlled valve to close the system, as part of an optional gateway module added to the integrated treatment system of claim 1. The sensors could include instruments for pH, Cl₂, TDS, and radiation to identify the presence of incoming threat agents and the ability to activate a high-speed, motor controlled valve to close the system and divert the aqueous solution or fluid to a drain if appropriate, depending on the contaminant and concentration.

3. The capability of additional pre-treatment added to the integrated treatment system of claim 1. Depending on the characteristics of the incoming water supply or fluid stream such pretreatment could include screens, particulate filters, adjustment of hardness or softness, or other devices to physically and chemically prepare the incoming aqueous or fluid solution for the treatment process.

4. The ability to integrate system function and sequencing of the integrated treatment system of claim 1, with a programmable logic controller (PLC) to link, monitor, and manage all system components. Such controller could also provide both on site and remote system monitoring, and data logging to store and compile reports of operation for later operator/management analysis.

5. The capability of installing RO treatment units in the integrated treatment system of claim 1, without the ROMEM device, to allow for flexibility in configuration and placement of the units.

6. The capability of including additional post-treatment designed to condition the product solution to meet the needs of the specific needs of the user, integrated with the treatment system of claim 1. Such post-treatment could include: an ion-exchange tank to help treat certain types of threat agent; a calcite tank to add minerals to improve taste and adjust pH of drinking water; a chlorine injector to add residual disinfectant for a water distribution system; or other post-treatment as required by the specific installation.

7. The capability of aggregating all the options described in claims 2 through 6, or any combination of those options to supplement the integrated aqueous solution treatment system of claim 1.

8. The ability to configure the integrated treatment system of claim 1, as a self-contained unit, including power from a portable electric generator (either powered by renewable energy such as solar or wind, or by conventional fossil-fuel based generators), mounted in a wheeled vehicle (trailer, van, or truck) for mobile deployment and operation.

9. The ability to mount the integrated aqueous solution treatment system of claim 1, in a surface or undersea vessel to provide shipboard potable water or decontaminate wastewater.

10. The capability of configuring the integrated treatment system of claim 1, as a skid mounted, self-contained unit, designed for air, rail, water vessel, or truck transport and delivery.

11. The capability of configuring the integrated treatment system of claim 1, as sub-system modules designed for flexibility in fitting into fixed spaces and openings in existing structures, which modules are then connected into the integrated system.

12. A fixed installation of the integrated aqueous solution treatment system of claim 1, designed to serve a specific fixed facility.
